(19) United States
(12) Patent Application Publication
(10) Pub. No.: US 2025/0341430 A1
(43) Pub. Date: Nov. 6, 2025

(54) TEMPERATURE CONTROLLER CIRCUIT, DEVICE AND METHOD

(71) Applicant: TDK ELECTRONICS AG, München (DE)

(72) Inventors: Sujan Chandra Das, Deutschlandsberg (AT); Subramanian Ravichandran, Deutschlandsberg (AT)

(21) Appl. No.: 18/866,417

(22) PCT Filed: Apr. 19, 2023
(86) PCT No.: PCT/EP2023/060115

§ 371 Date: Nov. 15, 2024

(30) Foreign Application Priority Data
May 19, 2022 (DE) 10 2022 112-594.7

(51) Int. Cl. G01K 7/24; G01K 1/02

(52) U.S. Cl. CPC G01K 7/24; G01K 1/026

(57) ABSTRACT

In an embodiment a temperature controller circuit includes an evaluation circuit and two or more sensor stages, wherein each sensor stage includes a sensor element and a sensor element controller and wherein the sensor stages are electrically connected in parallel.

### CROSS-REFERENCE TO RELATED APPLICATIONS

This patent application is a national phase filing under section 371 of PCT/EP2023/060115, filed Apr. 19, 2023, which claims the priority of German patent application 102022112594.7, filed May 19, 2022, each of which is incorporated herein by reference in its entirety.

### TECHNICAL FIELD

The application relates to a temperature controller circuit, a temperature sensor device and a method for operating the temperature sensor device.

### BACKGROUND

The increasing demand for temperature sensors that may utilize temperature controller circuits of sensor elements calls for cost-effective production, e.g. by reducing material and energy consumption. One essential requirement for high reliability is proper soldering of wires (mechanical, climatic, thermo-mechanical, chemical, thermal, light, etc.) in defined geometrical dimensions (soldering position with respect to chip, positioning, etc.) typically using solder paste, solder ball and solder bar. Currently the state-of-the-art technologies for soldering of wire contacted electronic components are dip soldering, overflow soldering, solder paste sintering.

However, these technologies result in high temperature exposure of both wire and chip and high flux deposition at chip level. Furthermore, recycling of unused solder material in dip soldering and overflow soldering process is required, resulting in accumulation of foreign materials. In addition thereto, conventional technologies are unable to adapt smaller chip dimensions for mass production.

Examples of NTC thermistor elements are known from document DE 10 2005 017 816 A1.

Conventional series connection of sensor elements is used to combine sensor elements to a temperature controller circuit. However, mere series connections have the disadvantage that series connections will end up with a high scrap rate due to interruptions in chip assembly. However, conventional parallel connections will end up with higher power source requirements.

Further, the need for high voltages in conventional circuits may increase space consumption and spatial dimensions when a Faraday cage for high voltage protection is needed.

### SUMMARY

Embodiments provide an improved temperature controller circuit.

The temperature controller circuit comprises an evaluation circuit and two or more sensor stages. Each of the two or more sensor stages comprises a sensor element and a sensor element controller. The sensor stages are electrically connected in parallel.

The parallel connection of the individual sensor stages with respect to each other allows for a reduced operation voltage because the full operation voltage is applied to each of the stages. Thus, there is no longer any need for a Faraday cage.

Further, the provision of a sensor element controller for each sensor stage ensures that the optimum power or load is applied on each sensor element. This is in contrast to known temperature controller circuits where—when configured in parallel and without a specific sensor element controller—the load for each individual sensor element may be different due to variances in the ohmic resistance of the individual sensor elements of the sensor stages.

Thus, with the configuration stated above, specifically with the parallel connection of the sensor stages and the provision of the sensor element controller, temperature controller circuits can be provided such that scrap reduction can be from 2% to 10% or even higher when interruptions via mechanical movements are concerned. Further, the detection of improper assembly of the final product is possible before the start of the final assembly process. Further, the costs for manufacturing equipment, for maintenance and self-calibration of the circuit and of the power source can be reduced. Further, space consumption is reduced. Further, it is possible to detect weak joints of soldering during processing.

Further, it is possible to read out individual temperatures of the individual sensor elements and to log the corresponding data. Further, it is possible to evaluate the individual resistances of the individual sensor elements.

Manufacturing of chips, e.g. NTC, PTC, or any passive components may require heat treatment (e.g. soldering, coating, aging). This heating can be generated by applying electrical power (P=V*I=I\hat{ }2*R) to a sensor element also known as Joule heating. Since the temperature of the element is a function of the applied power and a dissipation factor associated with heat conduction towards an environment of the sensor element and proportional to the required energy or power to increase the body temperature of the chip by 1 Kelvin, the desired temperature can be obtained by controlling the applied power which is possible via the temperature controller circuit. In addition to that with this circuit it is also possible to sense the chip's temperature by measuring the resistance during the heating process.

Further, it is possible that the sensor element of each stage is a sensor element with a temperature dependent resistance. Specifically, it is possible that the sensor element of each stage is selected from a thermistor, an NTC element (NTC=negative temperature coefficient), and a PTC (PTC=positive temperature coefficient).

Thus, a passive element can be used for the sensor element.

It is possible that the sensor element controller of each stage comprises an active element. Specifically, it is possible that the active element of the sensor element controller is selected from a voltage control element, a MOSFET (MOSFET=metal oxide semiconductor field effect transistor), a current controlled element, a BJT (BJT=bipolar junction transistor) and a controlled current source.

It is possible that in each sensor stage the sensor element and the sensor element controller are electrically connected in series or in parallel.

In contrast to conventional temperature controller circuits comprising parallel connections of sensor elements where the load for the different sensor elements is not balanced, leading to an increased probability of failure, the load for the sensor elements as described above is individually controlled via the sensor element controller such that a balanced load for each sensor element is possible. Thus, the probability of failure is reduced and the lifetime of the sensor elements is increased.

It is possible that the evaluation circuit is selected from a microcontroller, an ASIC (ASIC=application specific integrated circuit) and an FPGA (FPGA=field programmable gate array).

A temperature-dependent parameter of the sensor element can be derived from the control parameters of the individual sensor element controllers such as a voltage or a current. The temperature can be derived from the corresponding temperature-dependent parameter. This data processing can be performed by the evaluation circuit. Within the evaluation circuit further parameters e.g. parameters for a fitting curve or a lookup table can be stored such that the actual temperature can be computed from the temperature-dependent parameter. Specifically, it is possible that the temperature-dependent parameter of the sensor element is the sensor element's resistance.

It is possible that each sensor stage comprises an operational amplifier. The operational amplifier can be used for driving the sensor element controller of each sensor stage such that the voltage and/or current applied to the sensor element of the corresponding sensor stage is at its optimal operation conditions.

To that end, the corresponding operational amplifier can have an input, an inverted input in an output. The operational amplifier can be connected with its output to the sensor element controller of the corresponding stage. The inverted input can also be connected to the output of the operational amplifier. The non-inverted input of the operational amplifier can be connected to a further circuit element block of the temperature controller circuit. The additional circuit element block can be a voltage converter electrically connected between the evaluation circuit and the corresponding operational amplifiers. The voltage converter of the temperature controller circuit can also comprise two operational amplifiers that may be electrically connected in series.

The voltage converter can be used with a control signal from the evaluation circuit. The voltage converter can be used to convert a control signal, e.g. a PWM signal (PWM=pulse width modulation) to an analog voltage and/or amplify it.

Specifically, the voltage converter can comprise a series inductance element and a shunt capacitance element functioning as a low pass filter.

It is possible that each sensor stage further comprises an output operational amplifier. The operational amplifier can be electrically connected between the sensor stage and input port of the evaluation circuit. The output operational amplifier can also comprise a non-inverted input, an inverted input and an output. The output of the output operational amplifier is electrically coupled to the evaluation circuit. The inverted input is electrically connected to the output of the output operational amplifier. The non-inverted input of the output operational amplifier is coupled to the sensor stage.

Further, it is possible that each sensor stage comprises a voltage divider.

The voltage divider can comprise two resistance elements electrically connected in series, e.g. between the sensor element of the corresponding stage and ground. At a node between the two resistance elements of the voltage divider, the corresponding non-inverted input of the output operational amplifier is electrically coupled to the voltage divider.

It is possible that the temperature controller circuit further comprises an ADC (ADC=analog-to-digital converter) electrically connected at an input of the evaluation circuit.

Via the ADC the temperature controller circuit can convert an analog signal such as the above-described voltage or current obtained from the stage into a digital signal that can be processed by digital circuitry of the evaluation circuit.

It is possible that the ADC has an input for each of the sensor stages.

It is possible that the temperature controller circuit further comprises a voltage divider electrically connected to the ADC. Specifically, the voltage divider connected to the ADC can also comprise two resistance elements electrically connected in series between a voltage supply connection of the temperature controller circuit and ground. Again, the ADC can be coupled via an operational amplifier to the voltage divider, specifically to the central node between the two resistance elements of the voltage divider. The operational amplifier connected to the voltage divider connected to the voltage supply port can comprise an output, a non-inverted input and an inverted input, where the inverted input is electrically connected to the output and the non-inverted input of the operational amplifier is connected to the node between the two resistance elements of the voltage divider. As described above, it is possible that the temperature controller circuit further comprises the voltage converter, the voltage converter can be electrically arranged between an output of the evaluation circuit and respective inputs of the sensor stages. The voltage converter can comprise two operational amplifiers electrically connected in series between the evaluation circuit and the operational amplifiers for driving the sensor element controllers of the stages. Specifically, a first operational amplifier can be electrically coupled via its non-inverting input to the evaluation circuit while the inverted input is electrically connected to the output of the first operational amplifier of the voltage converter. Further, the output of the first operational amplifier of the voltage converter can be connected to the non-inverted input of a second operational amplifier of the voltage converter where the inverted input of the second operational amplifier is coupled, e.g. via a resistance element, to the output of the second operational amplifier of the voltage converter where the output is coupled to non-inverted inputs of the corresponding input operational amplifiers driving the sensor element controllers.

It is possible that the number of sensor stages is two or larger. Specifically, it is possible that the number of sensor stages is 10 or larger, 100 or larger or 1000 or larger. A preferred number of parallel sensor stages may be 40, 100 or 500.

When the circuitry of the sensor circuit is realized as integrated circuitry in an IC chip, then the number of sensor stages is virtually unlimited and can even be larger than 10000 allowing for an extreme precision in temperature measurement of the sensor elements.

It is possible to realize the temperature controller circuit as circuitry in a temperature sensor device such that the temperature sensor device comprises the temperature controller circuitry as described above.

It is possible that in the temperature sensor device, the circuitry of the sensor stages or the evaluation circuit is provided in a chip containing the sensor elements.

Specifically, it is possible that the chip comprises the active circuit elements of the sensor element controllers of the stages and the active circuitry of the optional ADC and of the evaluation circuit.

At an output port of the evaluation circuit, a display can be provided such that an environmental parameter such as a resistance or a temperature corresponding to the resistance of the sensor elements can be displayed.

It is possible that the temperature controller circuit further comprising a low pass filter including a series inductance element and a shunt capacitance element.

It is possible that the temperature controller circuit further comprises a display for continuous monitoring the presence of a faulty sensor stage.

In this context, a sensor stage or its sensor element can became faulty during operation because operation may involve heating and heating can lead to faster material degradation.

It is possible that the sensor device further comprises a thermal insulation of one or more of sensor elements. The insulation can be realized as wire(s) to the sensor elements where the wire(s) has a thermal conductivity lower than the thermal conductivity of copper or aluminium. A reduced thermal conductivity reduces the electric power needed to maintain a desired temperature level.

Further embodiments provide a method for sensing a temperature with a configuration as described above, specifically with two or more parallel sensor stages comprises distributing the temperature sensing over two or more sensor stages while controlling the power or the load at each sensor stage.

It is possible that the voltage converter for controlling the input operational amplifiers controlling the sensor element controllers is a PWM analog voltage converter (PWM=pulse width modulation).

The sensor element controllers can be electrically connected between the sensor elements and ground where a further shunt element can be electrically connected between the sensor element controller and ground. The corresponding shunt may be used to measure the current flow through the sensor element via the sensor element controller.

The voltage dividers can be used to downscale a corresponding voltage applied to the voltage divider by a certain ratio where the ratio is determined by the ratio of the two resistance values of the series connection of resistance elements.

The output operational amplifiers can act as voltage buffers that can be used to convert high impedance voltage signals to low impedance voltage signals to protect the downstream ADC and/or microcontroller from overvoltage.

The ADC can be used to read all analog signals and convert the analog signals to digital signals read by the evaluation circuit.

The voltage converter, e.g. in the form of a PWM analog voltage converter can convert a PWM signal provided by the evaluation circuit to an analog signal. This analog signal may then be applied to the gate connection of the MOSFET as part of the sensor element controller, e.g. via a further voltage buffer realized by the input operational amplifiers.

The evaluation circuit can be used to perform numerical calculation and to send the corresponding process data to a display. The evaluation circuit can also be used to control the current flow through the sensing elements by controlling the duty cycle of a PWM signal applied to the voltage converter.

It is possible to convert a measured environmental parameter such as a temperature-dependent resistance into a temperature via the Steinhart and Hart equation.

It is possible that the method sensing a temperature comprising determining and/or measuring a current through one or several or all sensor elements.

### BRIEF DESCRIPTION OF THE DRAWINGS

Working principles and central circuit elements providing corresponding functionality are shown in the accompanying schematic figures.

FIG. 1 shows an overview over circuit blocks of the temperature controller circuit;

FIG. 2 shows a perspective view on a chip between two wires wherein the sensor element can be realized;

FIG. 3 shows a plurality of three sensor stages electrically connected in parallel to one another;

FIG. 4 illustrates a further possibility of realizing three sensor stages;

FIG. 5 illustrates a third possibility of realizing three sensor stages; and

FIG. 6(A-B) illustrates a specific variant of the temperature controller circuit involving the sensor stages as shown in FIG. 3.

### DETAILED DESCRIPTION OF ILLUSTRATIVE EMBODIMENTS

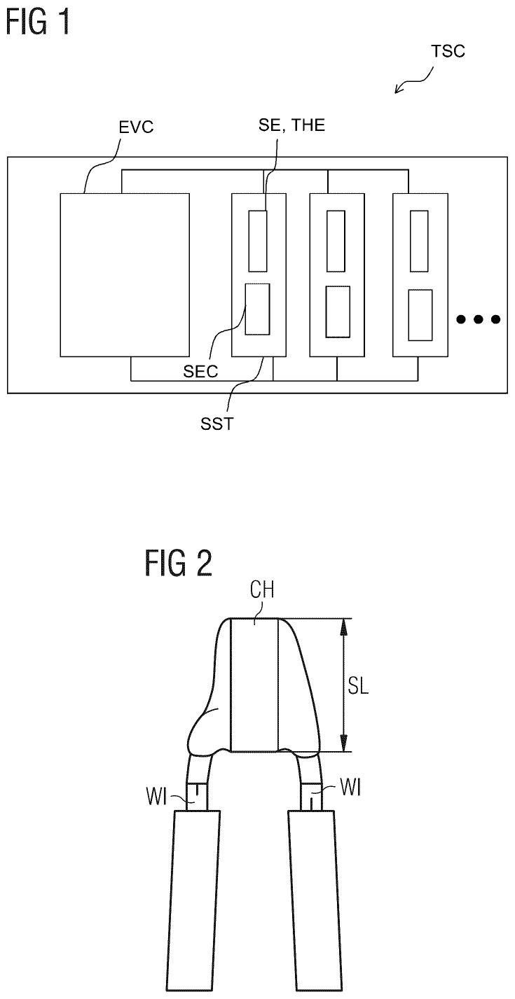

FIG. 1 illustrates central functional blocks of the temperature controller circuit TCC. The temperature controller circuit TCC comprises an evaluation circuit EVC and three sensor stages SST where the temperature controller circuit is not limited to three sensor stages as indicated by the three dots. The number of sensor stages of the temperature controller circuit is only essentially limited by the available area or volume for establishing the sensor stages. Each sensor stage is electrically coupled in parallel to the respective other sensor stages. Each sensor stage SST comprises a sensor element SE and a sensor element controller SEC. The sensor element SE can be realized as a circuit element with a temperature-dependent behaviour such as a temperature-dependent resistance, e.g. a thermistor THE.

FIG. 2 illustrates the arrangement of a chip CH at the two tips of wires WI. The chip CH is soldered at a certain solder length SL to the wires WI.

It is possible that the chip CH essentially contains only the sensor elements SE, e.g. the thermistors. However, it is also possible that the chip CH comprises a plurality of further circuit elements of the temperature controller circuit or even all of the circuit components of the temperature controller circuit.

Electric power can be applied for operating the temperature controller circuit via the wires WI or the wires can be used to apply corresponding voltage or current to the sensor element realized in the chip CH.

The fact that the sensor element is controlled via the sensor element controllers results in an improved reliability and lifetime as the load or electric power dissipating at the chip CH is controlled and does not exceed critical values that may risk the mechanical stability of the solder connection.

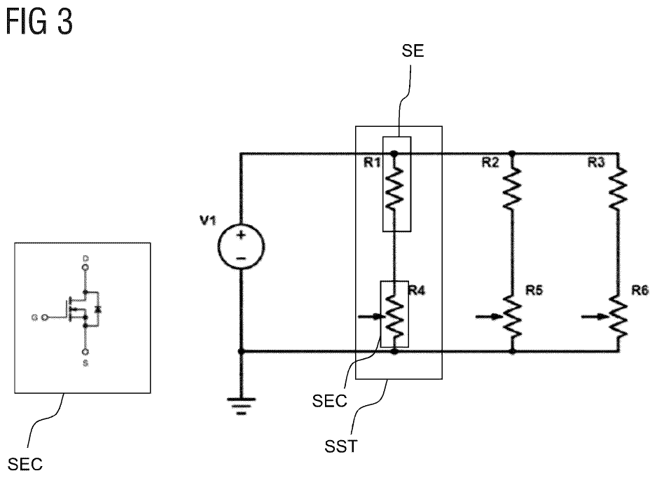

FIG. 3 illustrates a possible realization of three parallel sensor stages SST, where each sensor stage comprises a resistance element as sensor element SE. Further, each stage comprises a sensor element controller SEC. The sensor element controller SEC may be realized as an active switch such as a field effect transistor, such as an MOSFET as illustrated in the left part of FIG. 3. The MOSFET comprises a drain connection D, a source connection S and a gate connection G. Via the gate connection G the electric resistance between source S and drain D can be configured such that the load or dissipated power at the sensor element SE in the right part of FIG. 3 is controlled and limited to non-critical values.

In the configuration shown in FIG. 3, each sensor stage SST is connected to the same electric potential provided by the voltage source.

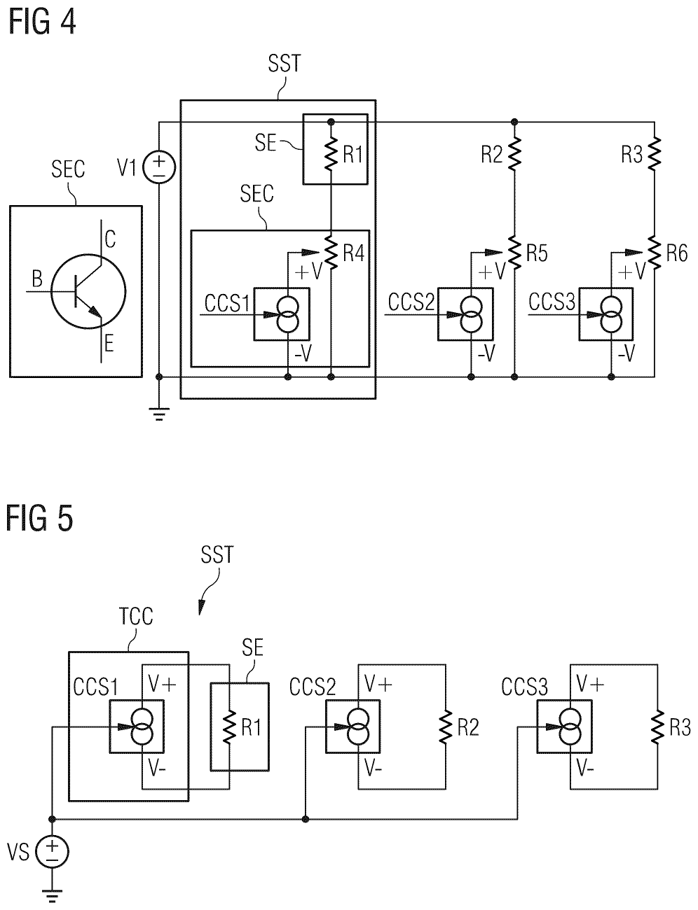

In contrast, FIG. 4 illustrates a variant of the plurality of sensor stages SST where in each sensor stage the sensor element controller SEC is realized as a BJT (BJT=bipolar junction transistor) shown in the left-hand side of FIG. 4. The BJT comprises a collector connection C, an emitter connection E and a base connection B via which the behaviour of the controller SEC can be determined.

Again, similar to the version shown in FIG. 3, each sensor stage SST is connected to the same electric potential.

In contrast thereto, FIG. 5 shows a version where individual power supply lines provide the individual sensor stages SST.

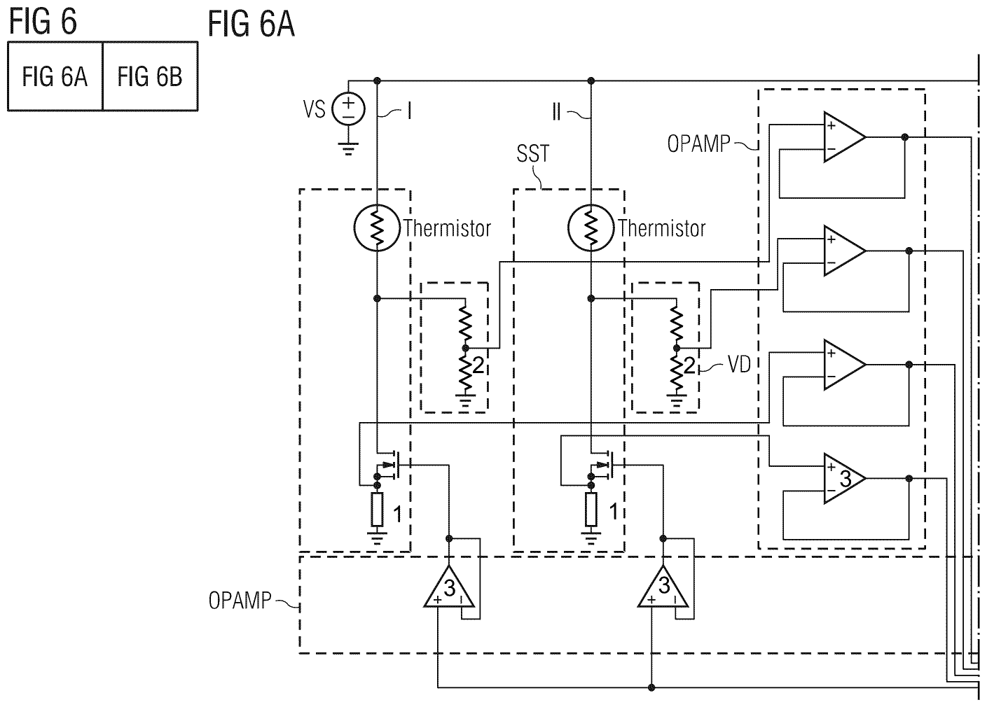

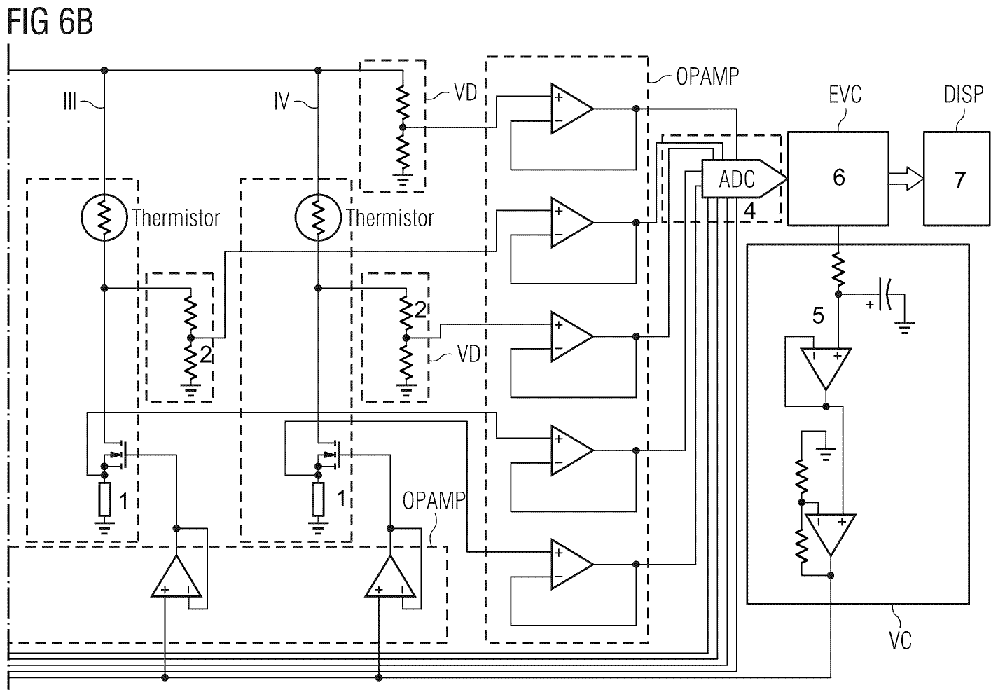

FIG. 6 illustrates a possible realization of the temperature controller circuit TCC where the temperature controller circuit TCC comprises the four parallel sensor stages SST I, II, III, IV. Each sensor stage SST comprises a thermistor electrically connected in series with a semiconductor switch. One electrode of the thermistor realizing the sensor element is connected to a voltage supply line while the respective other electrode of the thermistor is connected to the semiconductor switch and to a voltage divider VD. Each semiconductor switch of each stage SST realizes the sensor element controller and is connected to ground via shunt circuit element. Each voltage divider VD comprises a series connection of resistance elements where the ratio of the resistance values of the resistance elements determine the voltage conversion rate. Each of the active semiconductor switches realizing the sensor element controller SEC is coupled to an input operational amplifier such that there are four input operational amplifiers for the four stages I, II, III, IV. The input operational amplifiers OPAMP are connected between the semiconductor switch and the voltage converter VC that is arranged between the evaluation circuit EVC and the corresponding input operational amplifiers. The voltage converter VC comprises two operational amplifiers electrically connected in series.

Further, via the corresponding voltage dividers VD, each sensor stage SST is connected via an output operational amplifier to an ADC that converts the analog signals of the operational amplifiers into an additional signal for processing with the evaluation circuit EVC. The ADC obtains electric power or an electric signal via a further operational amplifier that obtains electric power from a further voltage divider VD that is connected to the voltage source VS.

Further, the evaluation circuit EVC is coupled to a display DSP for providing an optical representation of the measured temperature.

The temperature controller circuit is not limited to technical details shown above. Temperature controller circuits comprising further circuit elements such as further overvoltage protection elements or further circuit elements for providing electric energy are also possible.

1.-21. (canceled)

22. A temperature controller circuit comprising:
an evaluation circuit; and
two or more sensor stages,
wherein each sensor stage comprises a sensor element and a sensor element controller, and
wherein the sensor stages are electrically connected in parallel.

23. The temperature controller circuit according to claim 22, wherein the sensor element of each stage is selected from a temperature dependent resistive element, a thermistor, an NTC element, or a PTC element.

24. The temperature controller circuit according to claim 22, wherein the sensor element controller of each stage comprises an active element selected from a voltage-controlled element, a MOSFET, a current controlled element, a BJT, or a controlled current source.

25. The temperature controller circuit according to claim 22, wherein in each sensor stage the sensor element and the sensor element controller are electrically connected in series or in parallel.

26. The temperature controller circuit according to claim 22, wherein the evaluation circuit is selected from a computer, a microcontroller, an ASIC or a FPGA.

27. The temperature controller circuit according to claim 22, wherein each sensor stage comprises an operational amplifier configured for driving the sensor element controller.

28. The temperature controller circuit according to claim 22, wherein each sensor stage comprises an output operational amplifier.

29. The temperature controller circuit according to claim 22, wherein each sensor stage comprises a voltage divider.

30. The temperature controller circuit according to claim 22, further comprising an ADC electrically connected at an input of the evaluation circuit.

31. The temperature controller circuit according to claim 30, further comprising a voltage divider electrically connected to the ADC.

32. The temperature controller circuit according to claim 22, further comprising a voltage converter between an output of the evaluation circuit and an input of each sensor stage.

33. The temperature controller circuit according to claim 32, wherein the voltage converter comprises two operational amplifiers.

34. The temperature controller circuit according to claim 22, further comprising a low pass filter including a series inductance element and a shunt capacitance element.

35. The temperature controller circuit according to claim 22, wherein a number of sensor stages is larger than 2.

36. The temperature controller circuit according to claim 22, further comprising a configured for monitoring a presence of a faulty sensor stage.

37. A temperature sensor device comprising:
the temperature controller circuit according to claim 22.

38. The temperature sensor device according to claim 37, wherein a circuitry of the sensor stages or the evaluation circuit is a chip containing the sensor elements.

39. The temperature sensor device according to claim 37, further comprises a thermal insulation of the sensor elements.

40. The temperature sensor device according to claim 39, wherein the thermal insulation includes a wire to the sensor elements, and wherein the wire has a thermal conductivity lower than a thermal conductivity of copper (Cu) or aluminium (Al).

41. A method for sensing a temperature utilizing the temperature sensor device according to claim 37, the temperature comprising:
distributing the temperature sensing over 2 or more sensor stages while controlling a power or a load at each sensor stage.

42. The method according to claim 41, further comprising determining and/or measuring a current through one or several or all sensor elements.
